(19) United States
(12) Patent Application Publication
(10) Pub. No.: US 2024/0261619 A1
(43) Pub. Date: Aug. 8, 2024

(54) Paschima Stretch Box System

(71) Applicant: Roman Simon, Hadera (IL)

(72) Inventor: Roman Simon, Hadera (IL)

(21) Appl. No.: 18/444,722

(22) Filed: Feb. 18, 2024

Related U.S. Application Data
(60) Provisional application No. 63/446,854, filed on Feb. 19, 2023.
(60) Provisional application No. 63/462,972, filed on Apr. 29, 2023.

(30) Foreign Application Priority Data
Feb. 7, 2023 (CN) 2023300377915
Feb. 15, 2023 (CN) 2023300558652
Mar. 16, 2023 (CN) 2023205158656
Apr. 7, 2023 (CN) 2023201829676
Apr. 24, 2023 (CN) 2023302313814
Jul. 4, 2023 (CN) 2023217432172
Jul. 10, 2023 (IL) 71073

(51) Int. Cl. A63B 21/00; A63B 23/00; A63B 23/02

(52) U.S. Cl. CPC A63B 21/00047; A63B 21/00178; A63B 23/0233; A63B 2023/006

(57) ABSTRACT

A stretch box system is a generally rectangular box including five panels which are attached to each other. The box has a variety of apertures through the side panels of the box. The apertures through opposing sides of the box generally align. In some methods of use, the user may place their feet against the box and reach forward to grasp the apertures or the crossbars formed by two adjacent apertures. The user may choose to grasp any number of the apertures or crossbars, and as their range of flexibility improves, they may grasp more distant apertures or crossbars to increase the intensity of the stretch.

### CROSS-REFERENCE TO RELATED APPLICATIONS

This application claims benefit of priority with U.S. Provisional Application Ser. No. 63/446,854, filed Feb. 19, 2023; No. 63/462,972, filed Apr. 29, 2023; the entire contents of which are hereby incorporated by reference. There are other international applications and/or international patents listed on the ADS to which this application claims priority.

### BACKGROUND

### Field of the Invention

This invention relates to exercise equipment; more particularly, to stretching devices.

### Description of the Related Art

In human physiology a forward bend is defined as moving the top part of the body forwards and downwards. Forward bend provides a strong stretch for the back of the body and it is a precursor to more intense stretches and movements. Yet forward bends can also be a challenge to many people, especially those with tight hamstrings, back problems etc.

### SUMMARY

The disclosure concerns an exercise device that enables a user to stretch their muscles. The device takes the form of a five-sided rectangular box. The box has holes through some or all of the lateral sides of the box. Two adjacent holes form a crossbar between them which the user may grasp when using the box to stretch.

In one method of use, the user may stand on the box and grasp the holes or crossbars of the box. In another method of use, the user may assume a seated position with their feet against the box and grasp the holes or crossbars of the box. As the user bends forward or extends their legs the depth of the forward bend is improved. When using the box user may gently push forwards with their feet while pulling backwards with their hands. This technique helps the user stretch the back side of their body, including but not limited to their hamstrings and back. With repeated practice over time, the user may be able to reach their hands to the next further hole or crossbar.

There are various sizes and shapes which the rectangular box may take. There are also various hole sizes and hole shapes which provide the user with various types of stretching exercises and various stretching exercise levels.

### BRIEF DESCRIPTION OF THE DRAWINGS

Other features, combinations, and embodiments will be appreciated by one having the ordinary level of skill in the art of exercise devices and accessories upon a thorough review of the following details and descriptions, particularly when reviewed in conjunction with the drawings, wherein:

FIG. 1 shows an isometric view of the stretch box system in accordance with a first illustrated embodiment; and

FIG. 2 shows an isometric view of the stretch box system in accordance with a first illustrated embodiment;

FIG. 3 shows a back profile view of the stretch box system in accordance with a first illustrated embodiment;

FIG. 4 shows a front profile view of the stretch box system in accordance with a first illustrated embodiment;

FIG. 5 shows a left profile view of the stretch box system in accordance with a first illustrated embodiment;

FIG. 6 shows an isometric view of the stretch box system in accordance with a first illustrated embodiment;

FIG. 7 shows an isometric profile view of the stretch box system in accordance with a second illustrated embodiment;

FIG. 8 shows a right profile view of the stretch box system in accordance with a second illustrated embodiment;

FIG. 9 shows an isometric view of the stretch box system in accordance with a second illustrated embodiment;

FIG. 10 shows an isometric view of the stretch box system in accordance with a third illustrated embodiment;

FIG. 11 shows a back profile view of the stretch box system in accordance with a third illustrated embodiment; and

FIG. 12 shows an isometric view of the stretch box system in accordance with a fourth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “APERTURE” means a hole or penetration through a panel.

Unless explicitly defined herein, terms are to be construed in accordance with the plain and ordinary meaning as would be appreciated by one having skill in the art.

### GENERAL DESCRIPTION OF EMBODIMENTS

The stretch box system, or simply “the box,” takes form of a generally rectangular prism comprising five sides. Each of the sides of the box are referred to as panels herein. There box may have a top panel, and four side panels. The four side panels may be identified as a front panel, a back panel, a left panel, and a right panel. The panels may be attached to each other to form the box. The panels may be attached using methods known to one skilled in the art. The attachment methods may include but are not limited to wood joinery, glue, adhesive, and fasteners, or some combination thereof.

The box has an outer side comprising the outer surfaces of all the panels. The outer side is generally oriented away from the center of the box. The box has an inner side comprising the inner surfaces of all the panels. The inner side is generally oriented towards the center of the box.

For the purpose of description, a 3-dimensional axis system has been assigned to the box. The axis system includes an X-axis, a Y-axis, and a Z-axis. The Z-axis passes perpendicularly through the top panel. The X-axis passes perpendicularly through the left panel and the right panel. The Y-axis passes perpendicularly through the front panel and the back panel.

The holes through the panels described above are referred to as apertures herein. In some embodiments, the left panel and right panel may be configured with a plurality of apertures passing between the outer side and the inner side. The plurality of left panel apertures may substantially align with the plurality of right panel apertures. In some embodiments, the left panel may be configured with three apertures and the right panel may be configured with three apertures. In some embodiments, the left panel may be configured with five apertures and the right panel may be configured with five apertures.

In some embodiments, the front panel and back panel may be configured with a plurality of apertures passing between the outer side and the inner side. The plurality of front panel apertures may substantially align with the plurality of back panel apertures. In some embodiments, the front panel may be configured with two apertures and the back panel may be configured with two apertures. In some embodiments, the front panel may be configured with three apertures and the back panel may be configured with three apertures.

In some embodiments, the left panel, the right panel, the front panel, and the back panel may be configured with a plurality of apertures passing between the outer side and the inner side.

The apertures may be shaped in various ways. In some embodiments, the apertures may be elongated apertures forming a slot-shaped hole. The elongated apertures are wider in one first dimension and narrower in a second perpendicular dimension. For the purposes of description, the diameter of the elongated aperture wider dimension is referred to as the major diameter, and the diameter of the elongated aperture in the narrower dimension is referred to as the minor diameter. In some embodiments, the major diameter of the elongated apertures may be generally parallel with the X-axis of the box. In some embodiments, the major diameter of the elongated apertures may be generally parallel with the Y-axis of the box. In some embodiments, the major diameter of the elongated apertures may be generally parallel with the Z-axis of the box.

The apertures may be circular apertures forming a generally circular-shaped hole. In some embodiments, the apertures on the front panel and the back panel are circular-shaped. In some embodiments, there are two apertures on the front panel and two apertures on the back panel. Apertures on the front panel may substantially align with apertures on the back panel. In some embodiments, a user may insert a pole through a pair of aligned apertures.

A user may insert a pole through the apertures to serve as a grasping point. In some embodiments, the user may insert a pole through an aperture on the left panel and an aperture on the right panel. The user may grasp the ends of the pole which protrude out from the left panel outer side or the right panel outer side to assist in their stretching exercises. Similarly, a user may insert a pole through the aperture on the front panel and an aperture on the back panel. Again, the user may grasp the ends of the pole which protrude out from the front panel outer side and the back panel outer side to assist in their stretching exercises.

In some embodiments, the panels may have notches disposed on the lower edge of the box. The lower edge of the box is in the opposite direction from the top panel. The notches are cavities or voids in the lower edge of the box. The notches serve as an additional location where the user may grasp the box.

In some embodiments, the box may have one notch on the left panel and one notch on the right panel. In some embodiments, the box may have one notch on the front panel and one notch on back panel.

The apertures, the notches, and the crossmembers or some combination thereof, may have rounded perimeter edges to make grasping them more comfortable and ergonomic for the user. In some embodiments, some or all of the perimeter edges of the box are rounded edges.

The panels may have a variety of thicknesses depending on the embodiment. In some embodiments, the panels have a thickness of between 10 mm and 20 mm. In some embodiments, the panel thickness may be greater than 20 mm. In some embodiments, the panel thickness may be less than 10 mm.

The distance between a panel's edge and an aperture may be referred to as a margin. In some embodiments, the margin distance may be varied to provide the user with a more gradual stretching progression. For example, the margin between the outer side of the top panel and the uppermost aperture on the front panel may be a given distance, margin A. Similarly, the margin between the outer side of the top panel and the most upper aperture on the back panel may also be a given distance, margin A. Then the margin between the outer side of the top panel and the uppermost aperture on the left panel, referred to herein as margin B, may be offset by half the length between adjacent apertures. The right panel uppermost aperture may be similarly offset.

Offsetting margin A with respect to margin B by half the length between adjacent apertures allows the user to scale the intensity of their stretch more gradually. For example, a user may first stretch by standing on the top panel and grasping the uppermost apertures having margin A on the front panel and back panel. When they are ready to progress the intensity of their stretch, instead of grasping the next aperture or crossmember they may rotate the box 90 degrees about the Z-axis under their feet. They may then grasp the uppermost apertures on the left panel and the right having margin B. When the user is ready to progress the intensity of their stretch again, they may again rotate the box 90 degrees about the Z-axis with respect to their feet placement. They may then grasp the second uppermost aperture on the front panel and back panel. Other embodiments of the box may take advantage of similar margin offset features to provide more stretching intensity options.

In some embodiments, the margin between the outer side of the front panel and the nearest aperture on the left panel and the nearest aperture on the right panel may be a given distance, margin C. In the same embodiment, the margin between the outer side of the back panel and the nearest aperture on the left panel and the nearest aperture on the right panel may be a given distance, margin D. If the distance of margin C is offset from the distance of margin D the user may be provided with a more gradual stretching progression by switching between having their feet against the front panel and having their feet on the back panel. In some embodiments, margin C may be offset from margin D by half the length between adjacent apertures.

The margin between the outer side of the top panel of the box and the nearest openings on the left panel and the right panel is approximately 1.5 times wider than the margin on the front panel and the back panel, shifting the crossbars on the left panel and right panel halfway further from the top panel outer side than the crossbars on the front panel and back panel. The purpose of this offset is as follows: once the user is comfortable with grasping on to, for instance, the uppermost crossbar on the front panel and back panel, they can turn the device 90 degrees about the Z-axis to use the next crossbars on the left panel and right panel. Thus, the user may stretch using half increments as opposed to grasping the second crossbar without turning the device. By alternating between sides on which the user holds onto the crossbars, the user can have a more gradual stretching process.

### Manufacturing

The fasteners used to attach the panels together can be obtained commercially. Alternatively, the box can be customized in accordance with the level and knowledge of one having skill in the art.

In the preferred embodiment, the panels may be generally made of wood materials. In some embodiments, the panels may be generally made of plastic materials. Otherwise, the panels can be fabricated in accordance with the level and knowledge of one having skill in the art.

Each of the components of the box and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

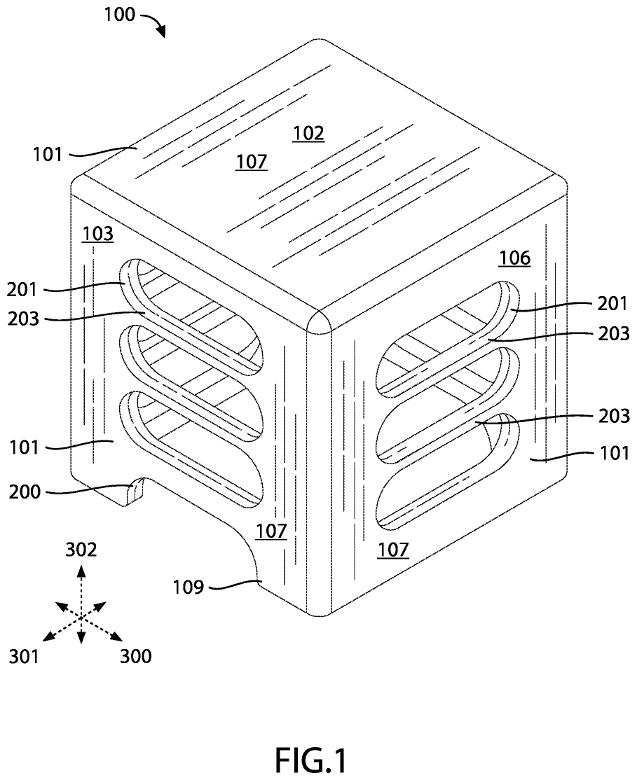

A first illustrated embodiment of the box (100) is shown in FIG. 1-FIG. 6. The box is shown from a top isometric perspective in FIG. 1 wherein a top panel (102), a front panel (103), and a right panel (106) are identified. All five panels are collectively referred to as panels (101). The outer surfaces of all the panels are referred to as the outer side (107) of the box. This embodiment of the box has three apertures (201) through each panel. The apertures are elongated apertures (203) in this embodiment. Two adjacent apertures form a crossbar (204) between the apertures. A notch (200) is shown along the lower edge (109) of the front panel. The 3-dimensional axis system is shown as well, and the directions of the X-axis (300), Y-axis (301), and Z-axis (302) are identified. Please note, the axes are actually meant to intersect in the center of the box, but they are shown displaced outside the box such that they may be more easily seen by the viewer.

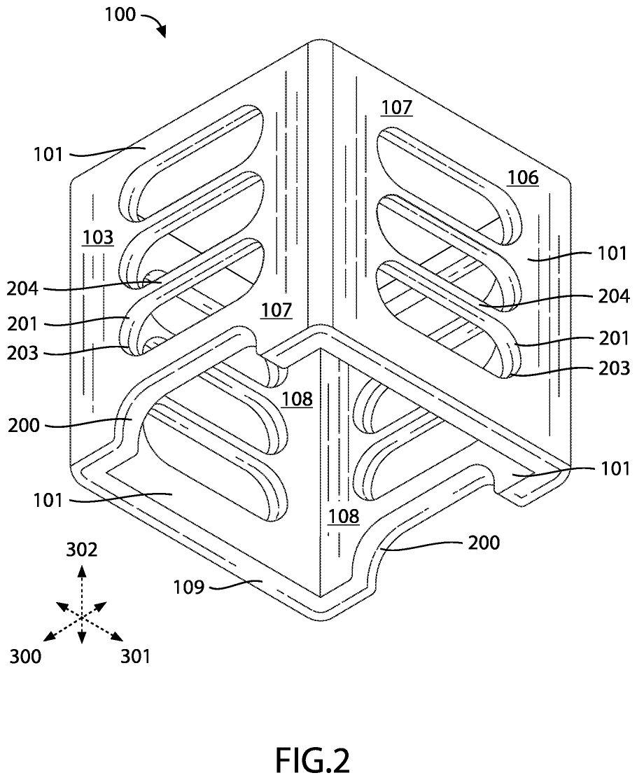

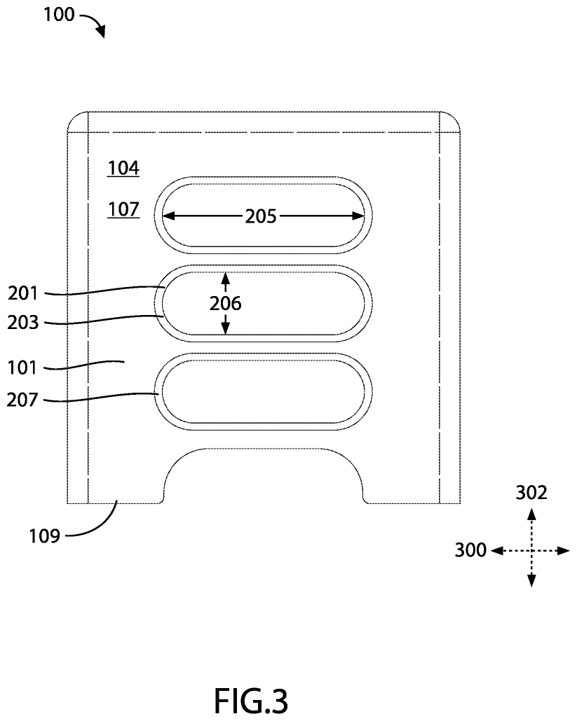

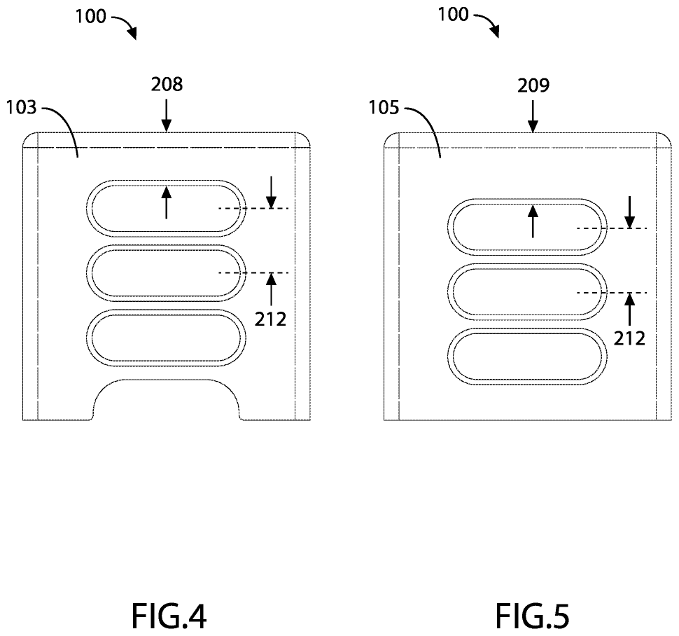

The inner side (108) of the box (100) comprising the inner surfaces of the panels (101) is shown in FIG. 2. A side profile view of the back panel (104) of the box is shown in FIG. 3. In FIG. 3 the major diameter (205) and minor diameter (206) of the elongated apertures are shown. In FIG. 4 and FIG. 5 the margin between the uppermost apertures (201) and the outer surface (107) of the top panel (102) are identified. In this embodiment, the top panel and back panel have margin A (208), and the left panel and right panel have margin B (209). The length (202) between apertures is also identified. By offsetting margin A from margin B by half the length a more gradual stretching progression is provided to the user. Other offset distances between margin A and margin B are possible in other embodiments. In some embodiments, there may be zero offset between margin A and margin B.

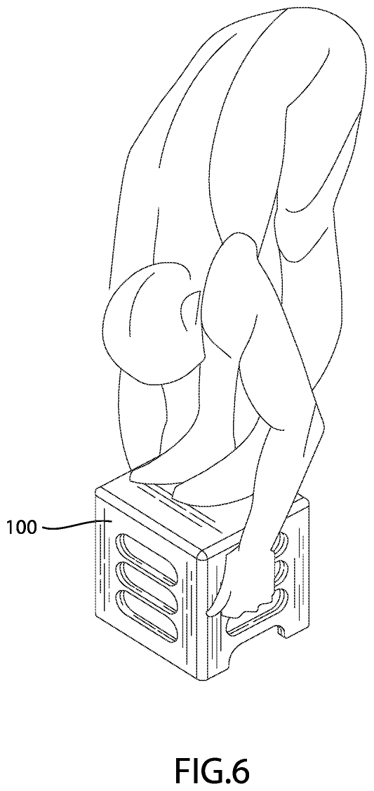

In FIG. 6 a user is shown using the first illustrated embodiment of the stretch box (100) system in a standing position. Other methods and techniques of using the box to stretch are possible.

### Second Illustrated Embodiment

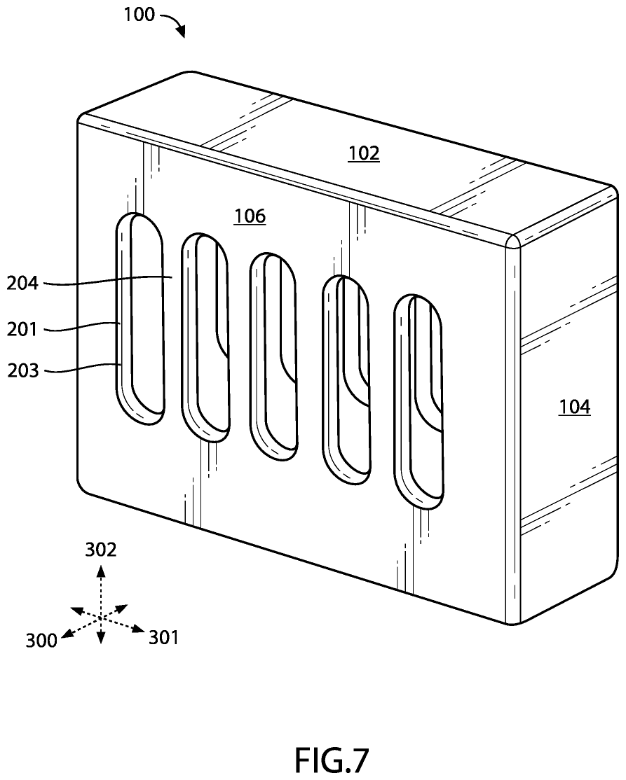

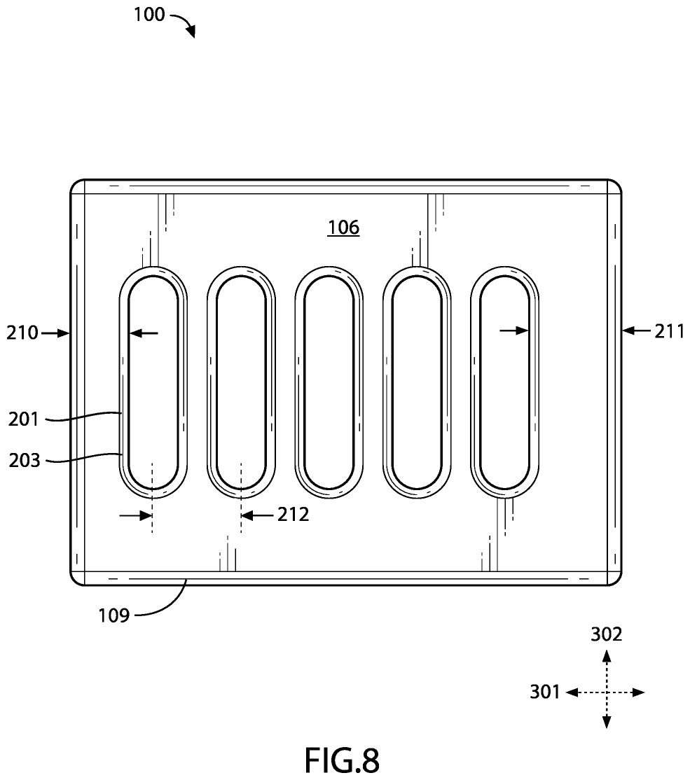

A second illustrated embodiment of the box (100) is shown in FIG. 7-FIG. 9. The box is shown from a top isometric perspective in FIG. 7 wherein a top panel (102), a back panel (104), and a right panel (106) are identified. This embodiment of the box has five apertures (201) through the left panel (105) and through the right panel. The apertures are elongated apertures (203) in this embodiment. Two adjacent apertures form a crossbar (204) between the apertures. The major diameter (205) of the elongated apertures in this embodiment are generally parallel with the Z-axis (302) of the box.

In FIG. 8 the margin between margin C (210) and margin D (211) are identified. In this embodiment, margin C is offset from margin D by half the length (212) of the apertures (201). This offset provides the user with a more gradual stretching progression.

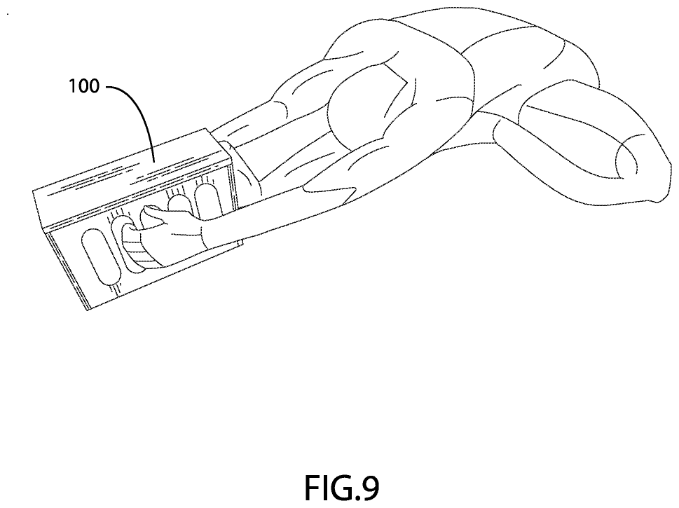

In FIG. 9 a user is shown using the second illustrated embodiment of the stretch box (100) system in a seated position. Other methods and techniques of using the box to stretch are possible.

### Third Illustrated Embodiment

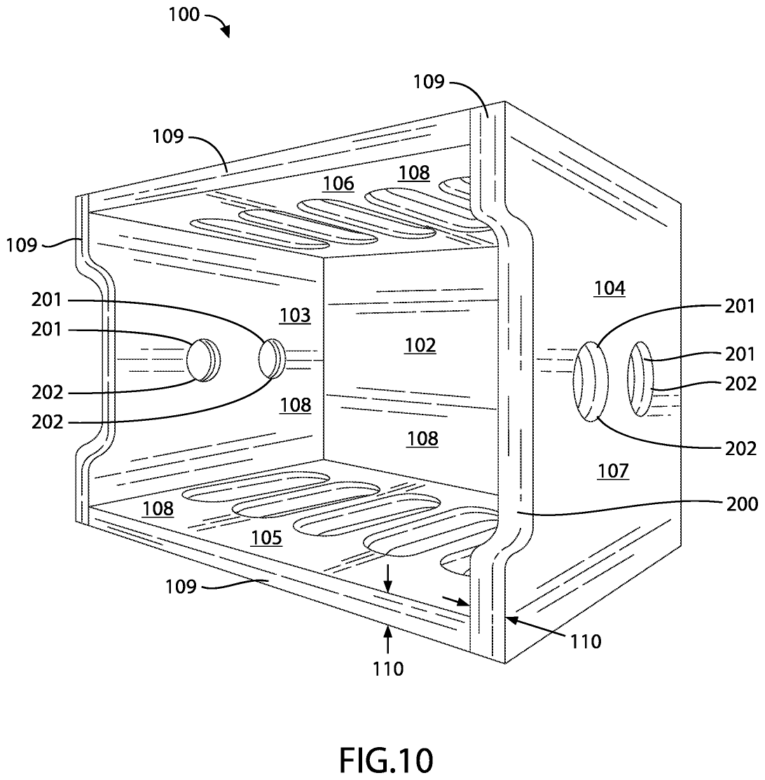

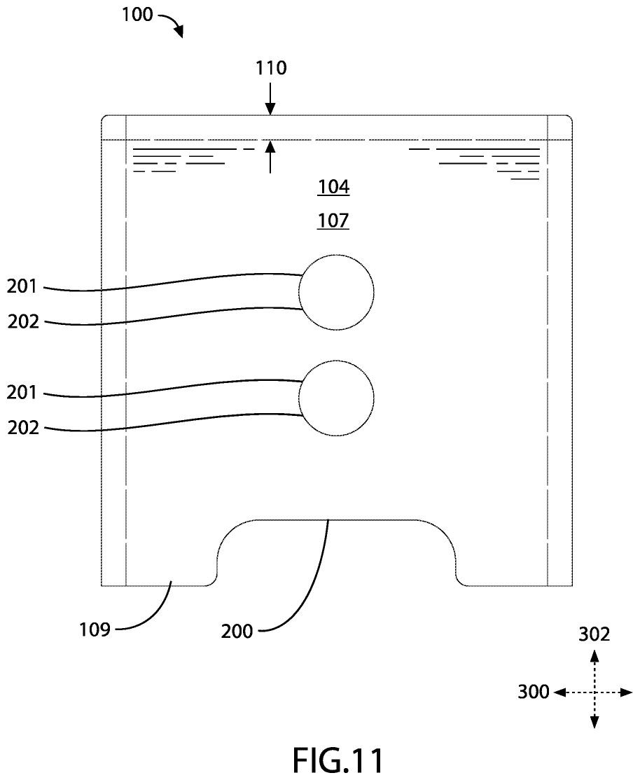

A third illustrated embodiment of the box (100) is shown in FIG. 10-FIG. 11. The box is shown from a bottom rear perspective in FIG. 10 wherein a top panel (102), a front panel (103), a back panel (104), a left panel (105), and a right panel (106) are identified. The inner side (108) and outer side (107) of the box are also identified. This embodiment of the box has five elongated apertures (203) passing through the left panel and through the right panel. In addition, this embodiment of the box has two circular apertures (202) passing through the front panel and through the back panel. Other embodiments of the box may have a different number of circular apertures.

In FIG. 10 two notches (200) are shown. One notch is disposed on the lower edge (109) of the front panel (103), and one notch is disposed on the lower edge of the back panel (104) are identified. The panel thickness (110) is also identified in three different locations in FIG. 10 and FIG. 11.

### Fourth Illustrated Embodiment

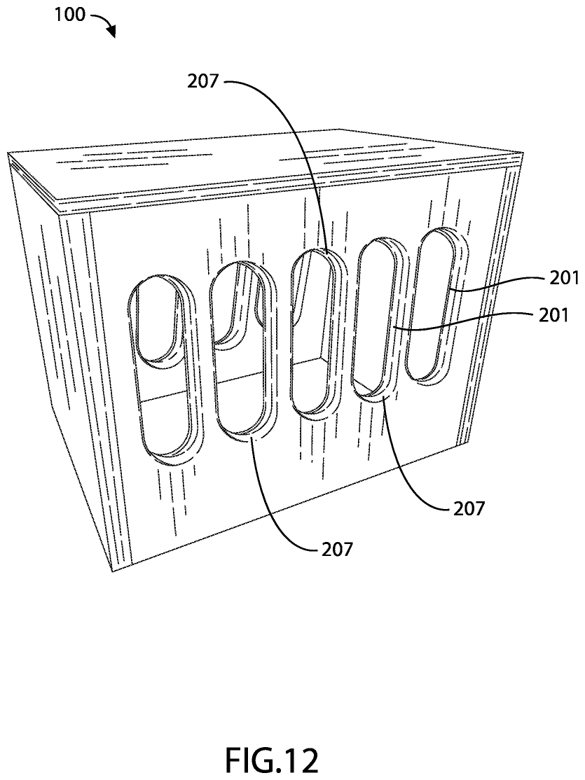

A fourth illustrated embodiment of the box (100) is shown in FIG. 12. The apertures (201) are shown with rounded edges. Rounded edges may be applied to any aperture. Rounded edges may be applied to the outer side (107) of an aperture. Rounded edges may be applied to the inner side (108) of an aperture.

Feature List

| | |
|---|---|
| Box | (100) |
| Panel | (101) |
| Top Panel | (102) |
| Front Panel | (103) |
| Back Panel | (104) |
| Left Panel | (105) |
| Right Panel | (106) |
| Outer Side | (107) |
| Inner Side | (108) |
| Lower Edge | (109) |
| Panel Thickness | (110) |
| Notch | (200) |
| Aperture | (201) |
| Circular Aperture | (202) |
| Elongated Aperture | (203) |
| Crossbar | (204) |
| Major Diameter | (205) |
| Minor Diameter | (206) |
| Rounded Edge | (207) |
| Margin A | (208) |
| Margin B | (209) |
| Margin C | (210) |
| Margin D | (211) |
| Length | (212) |
| X-axis | (300) |
| Y-axis | (301) |
| Z-axis | (302) |

What is claimed is:

1. A stretch box comprising:
a. A box having five panels, the five panels being attached to each other forming a generally rectangular prism shape, the box having an outer side facing generally outward away from the box, the box having an inner side facing generally inward, the panels comprising a top panel, a front panel, a back panel, a left panel, and a right panel, the left panel configured with a plurality of apertures passing between the outer side and the inner side, the right panel configured with a plurality of apertures passing between the outer side and the inner side.

2. The box of claim 1, further comprising:
a. Two notches, the notches being cavities disposed on a lower edge of the box, one notch being disposed on the left panel, one notch being disposed on the right panel.

3. The box of claim 1, further comprising:
a. Two notches, the notches being cavities disposed on a lower edge of the box, one notch being disposed on the front panel, one notch being disposed on the back panel.

4. The box of claim 1, wherein:
a. The front panel is configured with a plurality of apertures passing between the outer side and the inner side, and the back panel is configured with a plurality of apertures passing between the outer side and the inner side.

5. The box of claim 1, wherein:
a. The left panel is configured with three apertures, and the right panel is configured with three apertures.

6. The box of claim 1, wherein:
a. The left panel is configured with five apertures, and the right panel is configured with five apertures, and the apertures on the left panel substantially align with apertures on the right panel.

7. The box of claim 1, wherein:
a. The apertures disposed through the left panel are elongated apertures, and the apertures disposed through the right panel are elongated apertures, the elongated apertures having major diameters and an minor diameters.

8. The box of claim 1, wherein:
a. The apertures have rounded edges.

9. The box of claim 1, wherein:
a. A margin C is offset from a margin D by half the length between adjacent apertures.

10. The box of claim 1, wherein:
a. The length of a margin C is 1.5 times the length of a margin D.

11. The box of claim 1, wherein:
a. The panels of the box are generally made of materials selected from the group consisting of wood and plastic.

12. The box of claim 1, wherein:
a. The panel thickness is between 10 mm and 20 mm.

13. The box of claim 4, wherein:
a. The front panel is configured with two apertures, and the back panel is configured with two apertures.

14. The box of claim 4, wherein:
a. The front panel is configured with three apertures, and the back panel is configured with three apertures, the apertures on the front panel substantially align with apertures on the back panel.

15. The box of claim 4, wherein:
a. The apertures disposed through the front panel are circular apertures, and the apertures disposed through the back panel are circular apertures.

16. The box of claim 4, wherein:
a. A margin A is offset from a margin B by half the length between adjacent apertures.

17. The box of claim 4, wherein:
a. The length of a margin A is 1.5 times the length of a margin B.

18. The box of claim 7, wherein:
a. The major diameter of the elongated apertures are generally parallel to a X-axis.

19. The box of claim 7, wherein:
a. The major diameter of the elongated apertures are generally parallel to a Y-axis.

20. The box of claim 7, wherein:
a. The major diameter of the elongated apertures are generally parallel to a Z-axis.
